(19) United States
(12) Patent Application Publication
(10) Pub. No.: US 2003/0147064 A1
(43) Pub. Date: Aug. 7, 2003

(54) Laser based method and system for measuring separation distance between platforms

(75) Inventors: LaMar K. Timothy, Kaysville, UT (US); Michael D. Rivers, South Salt Lake, UT (US); Patricia F. Batzer, North Salt Lake, UT (US); Lawrence W. Pike, Salt Lake City, UT (US)

Correspondence Address: HARRINGTON & SMITH, LLP, 4 RESEARCH DRIVE, SHELTON, CT, 06484-6212, US

(73) Assignee: L-3 Communications Corporation, New York, NY

(21) Appl. No.: 10/067,617

(22) Filed: Feb. 4, 2002

(51) Int. Cl. G01C 3/08

(52) U.S. Cl. 356/4.01

(57) ABSTRACT

A method for determining a pre-selected point-to-point separation between a first craft C1 and a second craft C2 is provided. The method includes the step of providing two laser devices, L1, and L2, onboard each craft, C1 and C2, respectively. Then determining a desired skin location vector S2 of craft C2 in L2 coordinates and translating the skin location vector S2 to L1 coordinates; and then determining skin separation between crafts C1 and C2 in accordance with the translated skin location vector.

### BACKGROUND OF THE INVENTION

1. Field of the Invention

The present invention relates to station keeping by platforms in motion and, more particularly, to a laser based method and system for measuring separation distance between maritime vessels.

2. Prior Art

In general, maintaining a fixed or controlled separation between sea-going vessels in relative motion is often very difficult and dangerous. An exemplary example is replenishment of fuel and other supplies for ships at sea. In replenishment at sea two or more ships must remain close enough, often from 60 to 300 feet, to accomplish the transfer of supplies from one ship to the other. This is a dangerous situation when considering that the ships involved in such replenishments are usually a supply ship, such as a fuel supply ship, and a ship of the line, such as an aircraft carrier; and that the ships are under power while replenishment takes place. In addition, factors such as rough seas, high winds, and the relative disproportionate displacements of the ships can lead to disasters and tragedy if the ships are not kept a certain distance apart.

A manual method for maintaining distance between specific points of the ships, also called skin-to-skin separation, involves a manned rope, much like a very long tape measure, which is stretched between the massive ships. Then, separation is measured and maintained by a radio operator watching the rope and signaling a helmsman when something is amiss. But, when considering that the ships are under power, are very close, and are very large, it will be appreciated that if one of the ships is off course, even momentarily, collision and disaster may be imminent. It will be further appreciated that in rough seas the manual method may be prone to errors or that the manned ropes may not be visible to the radio operators. But, even if the ropes are visible, security may require radio silence and therefore slower manual communication, e.g., signal flags or messengers.

Other methods might include use of the ship's inertial navigation system (SINS) or the satellite based global positioning system (GPS). However, both these systems may not provide the necessary real time accuracy. Indeed, the margin of error for both systems may well exceed the separation distance between the vessels.

Therefore, it is desirable to provide a local method and system to dynamically measure and accurately report the rapidly changeable separation between moving platforms. It is also desirable that the method and system be radio silent, which satisfies security requirements, and be capable of operating in an adverse environment.

### SUMMARY OF THE INVENTION

The foregoing and other problems are overcome, and other advantages are realized, in accordance with the presently preferred embodiments of these teachings.

In accordance with one embodiment of the invention a method for determining a pre-selected point-to-point separation between a first craft C1 and a second craft C2 is provided. The method includes the steps of providing two laser devices, L1, and L2, onboard each craft, C1 and C2, respectively; then determining a desired skin location vector S2 of craft C2 in L2 coordinates and translating the skin location vector S2 to L1 coordinates; and finally determining skin separation between crafts C1 and C2 in accordance with the translated skin location vector.

In accordance with another embodiment of the invention a laser based system for measuring separation distance between a first platform and a second platform is provided. The system includes a lasing interrogator mechanically attached to the first platform via a first gimbal device adapted to provide interrogator azimuthal and elevation coordinates. The system also includes an interrogatee mechanically attached to the second platform via a second gimbal device, the second gimbal device adapted to provide interrogatee coordinates.

The invention is also directed towards a method for determining skin-to-skin distance using multi-purpose laser transceiver devices Laser_1 and Laser_2. The method includes the steps of determining a location vector S1 in Laser_1 coordinates and determining a second location vector S2 in Laser_2 coordinates. The next step determines the second location vector S2 in Laser_1 coordinates and gauges at least one skin-to-skin distance vector. Alternatively, location vector S1 could be determined in Laser_2 coordinates for determining the skin-to-skin distance.

### BRIEF DESCRIPTION OF THE DRAWINGS

The foregoing aspects and other features of the present invention are explained in the following description, taken in connection with the accompanying drawings, wherein:

FIG. 1 is a pictorial diagram of two ships incorporating features of the present invention and shows laser terminal coordinates showing two skin-to-skin distances normal to the centerline of ship 1;

FIG. 2 is a pictorial diagram showing a ship's coordinates and laser coordinates parallel to the ship's coordinates;

FIG. 3 is a representation of a laser pan-tilt pedestal coordinate system;

FIG. 4 is a representation of a first Euler rotation clockwise Az₂ about Zₐₓᵢₛ_{_{—}}_{P2} axis which is vertical out of the figure;

FIG. 4A is a matrix representation of the first Euler rotation shown in FIG. 4;

FIG. 5 is a representation of a second rotation, El₁+El₂ which is clockwise about second rotated Y_{P2}=Y′ and is vertical out of the figure;

FIG. 5A is a matrix representation of the second Euler rotation shown in FIG. 5;

FIG. 6 is a representation of a third rotation about the twice rotated Z_{P2}=Z″=Z_{P1} axis;

FIG. 6A is a matrix representation of the third Euler rotation shown in FIG. 6; and

FIG. 7 is a flow chart of one method for determining platform separation.

### DETAILED DESCRIPTION

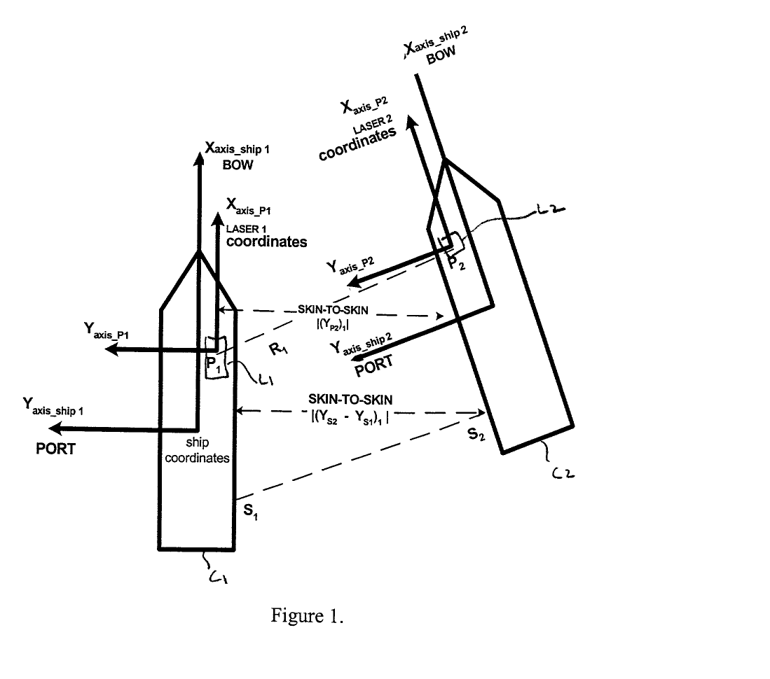

Referring to FIG. 1, there is shown a pictorial diagram of two ships incorporating features of the present invention. As shown, gimbaled lasers L1, L2 are pedestal (not shown) mounted aboard each ship C1, C2, respectively. Preferably, each laser pedestal is mounted facing towards ship's port or starboard depending on expected relative location of other ships. In alternate embodiments more than one gimbaled laser could be mounted aboard each ship. In the preferred embodiment the gimbaled laser devices are diode lasing transceivers operating at a wavelength of 1550 nm. Although the present invention will be described with reference to the embodiment shown in the drawings, it should be understood that the present invention could be embodied in many alternate forms of embodiments. For example, an alternate embodiment may include blue-green wavelength lasers, which are suited to undersea conditions.

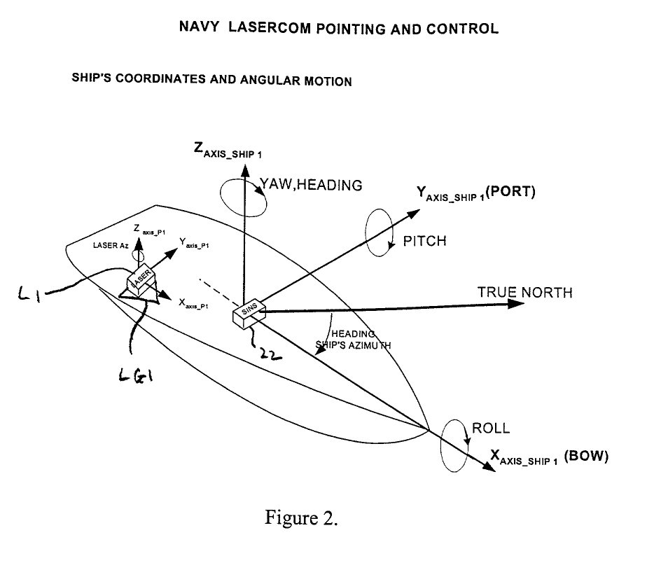

One feature of the invention advantageously measures ship separation in laser terminal coordinates and not in the ship's local level tangent plane. Thus, ship's roll, pitch, and yaw from the Ships Inertial Navigator System (SINS) (FIG. 2, item 22) are not required. Of the laser terminal coordinates that are employed, only the azimuthal angle and elevation angle of each laser terminal is necessary.

Referring also to FIG. 2 there is shown the shipboard laser L1 and it's coordinate system with respect to the ship's coordinate system. The laser L1 supported by gimbaled laser pedestal LG1, is P₁ at (0,0,0)₁, where the subscript denotes laser L1's coordinate frame. The laser axis, Xₐₓᵢₛ_{_{—}}_{P1}, is parallel to the ship's longitudinal axis and is positive towards the ship's bow. The axis Yₐₓᵢₛ_{_{—}}_{P1} is parallel to the deck and positive towards the ship's port. The axis Zₐₓᵢₛ_{_{—}}_{P1} is normal to the ship's deck or Xₐₓᵢₛ_{_{—}}_{P1}, Yₐₓᵢₛ_{_{—}}_{P1} plane. The axes form a right-handed set.

Positive ship's yaw or heading in the local level or earth's tangent plane is clockwise about the local vertical Z-axis, a left-handed rotation. Heading is measured from true north to the longitudinal axis of the ship. Positive pitch is bow down, a right-handed rotation about Y. And positive roll is port side down, a left-handed rotation about X. See FIG. 2. It should be appreciated that the ship's attitude definition is included for the purpose of complete coordinate definition and is not used or necessary in the present invention.

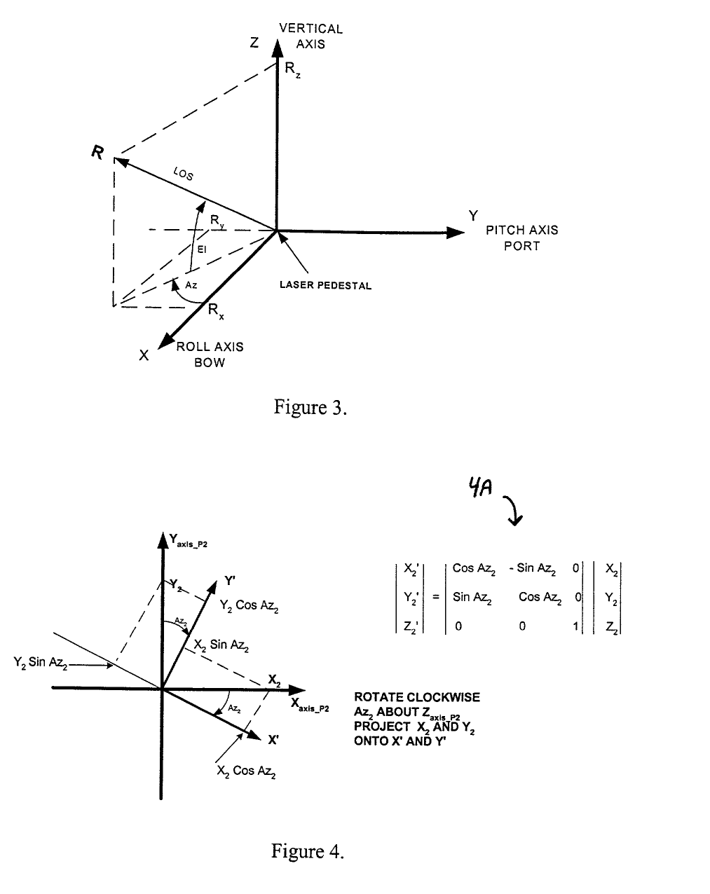

Referring also to FIG. 3 there is shown a laser pan-tilt pedestal coordinate system for either ship shown in FIG. 1. Pan angle is azimuth (Az) and tilt angle is elevation (E1). Line-Of-Sight (LOS) is the direction of the laser beam. The R vector is range measured at angles Az and E1 with magnitude |R|. The coordinate components R=(Rₓ, R_{y}, R_{z}).

The laser pan-tilt gimbaled pedestal for ship C1 is set to coordinates (0,0,0)₁ with its pan-azimuth rotations in the laser Xₐₓᵢₛ_{_{—}}_{P1},Yₐₓᵢₛ_{_{—}}_{P1} plane, a left-handed rotation about Zₐₓᵢₛ_{_{—}}_{P1}. The zero azimuth (Az₁) reference is aligned parallel to the ship's longitudinal axis towards the bow; azimuth is positive clockwise, a left-handed rotation, and the tilt-elevation angle (El₁) is positive upward measured from the Xₐₓᵢₛ_{_{—}}_{P1},Yₐₓᵢₛ_{_{—}}_{P1} plane of the ship C1, a left-handed rotation about once rotated Yₐₓᵢₛ_{_{—}}_{P1}. In the preferred embodiment the pan-tilt pedestal does not have slip rings and the pan-tilt pedestal rotation capability is limited to substantially +/−159° in pan-azimuth and up 31° and down 47° in tilt-elevation. In alternate embodiments with slip rings the pan-tilt pedestal rotation capability may be unlimited. The reported pan-tilt azimuth is preferably referenced to the laser X-axis and reads zero when the laser is aimed along the X-axis, which is towards the ship's bow. In the preferred embodiment a software bias is required to boresight the laser to reference laser's X-axis. The pan-tilt pedestal is preferably mounted to the ship such that the laser X-axis parallels the ship's X-axis and the laser's Y-axis parallels the ship's Y-axis to substantially within +/−1°. Laser L2 is similarly mounted on ship C2. In alternate embodiments any suitable orientation of the laser's pedestal may be used.

Still referring to FIG. 1, and also to FIG. 7, an example illustrating features of the present invention shows a desirable point (skin) location S1 (step 72) of craft C1 is at S1=(X_{S1}, Y_{S1}, Z_{S1})₁ in L1 coordinates and a desirable skin location S2 (step 71) on ship C2 at S₂=(X_{S2}, Y_{S2}, Z_{S2})₂ in L2 coordinates, where the S2 coordinates are referenced from P₂=(0,0,0)₂. The S2 coordinates may be determined from the known geometry of the ship C2 and stored in look up tables or calculated as necessary from the ship's known shape.

The laser terminal L2 on ship C2 is P₂ at (X_{P2}, Y_{P2}, Z_{P2})₁ in L1 coordinates measured at a range |R₁|:

(X_{P2})₁=|R₁| Cos (Az₁) Cos (El₁)

(Y_{P2})₁=−|R₁| Sin (Az₁) Cos (El₁)

(Z_{P2})₁=|R₁| Sin (El₁) Eq. set (1)

The pan-azimuth (Az₂) and tilt-elevation (El₂) of laser L2 along with Az₁, El₁, and range vector R₁ determine the location of S₂ in laser L1 coordinates.

Both laser terminals measure the same R vector when in track, except in reverse, i.e. R₁=−R₂. Furthermore, the R vector is oriented to each ship through the pan-tilt gimbals of each laser terminal except for a rotation about the R vector. With the lasers aimed at each other and parallel to the ship's Y pitch axis, relative rotations about the R vector occurs if each ship has a different pitch angle; and difference in pitch angles has negligible effect on skin-to-skin distance. Consequently, and advantageously, neither ship's inertial navigation is required to determine skin-to-skin distance.

The determination of ship C2 (in laser L2 coordinates) in laser L1 coordinates is uniquely achieved with three sequential Euler rotations (step 73), which rotate the laser L2 coordinates into laser L1 coordinates. For example, starting with laser L2 coordinates, let (X₂, Y₂, Z₂) be a point in L2 coordinates.

Referring to FIG. 4, the first Euler rotation rotates Az₂ clockwise about Zₐₓᵢₛ_{_{—}}_{P2}, where Zₐₓᵢₛ_{_{—}}_{P2} is vertical out of the paper.

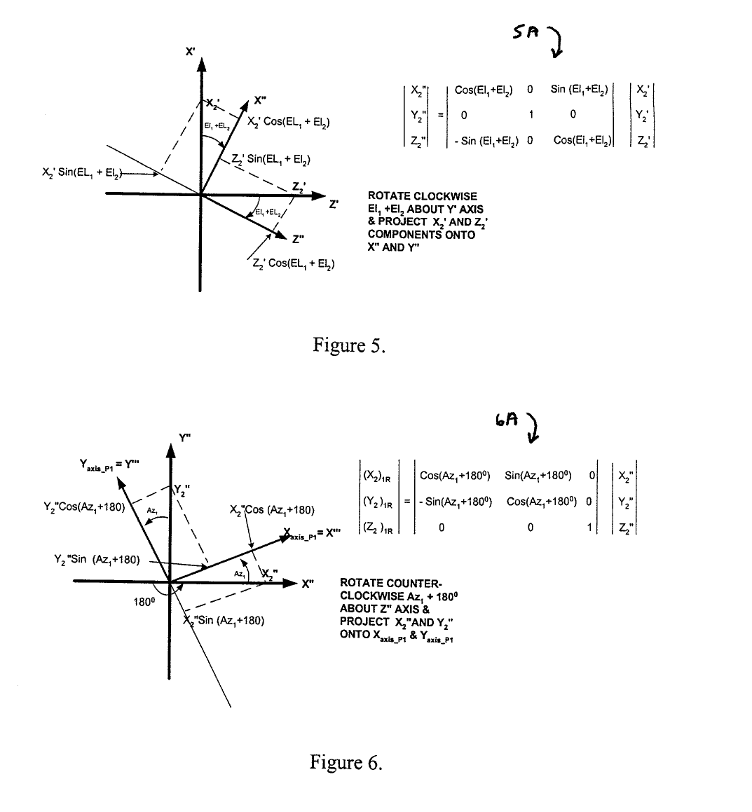

The second Euler rotation, referring also to FIG. 5, is in elevation, El₂+El₁, about the once rotated Y′=Yₐₓᵢₛ_{_{—}}_{P2}. Essentially there are two rotations: one in laser L2 and one in laser L1 coordinates which both happen to be about the same Y axis. The first elevation rotation with laser L2 is clockwise as shown in FIG. 4, whereas the second rotation with laser Li is counter clockwise and since the R vector reverses for laser Li relative to laser L2, El₁ is therefore added to El₂.

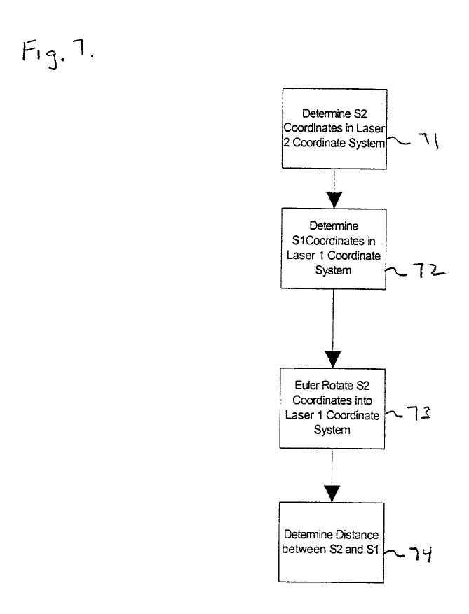

FIG. 6 shows the third Euler rotation where Az₁ is rotated about the twice rotated Z″=Zₐₓᵢₛ_{_{—}}_{P2}=Zₐₓᵢₛ_{_{—}}_{P1}. The rotation is counterclockwise but 180 degrees must be added to Az₁ to account for the reversal of the R vector. The Euler rotation matrices shown in FIGS. 4, 5, and 6 are sequentially rotated and substituted to represent the original vector (X₂, Y₂, Z₂)₂ in laser L2 coordinates in laser L1 coordinates as (X₂, Y₂, Z₂)₁R. The substitutions and matrix multiplies yields the following Eq. Set (3), where S=sine and C=cosine:

$$\begin{matrix}{( {X}_{2} )}_{1 R} = [ - S ( {Az}_{2} ) S ( {Az}_{1} ) - C ( {Az}_{2} ) C ( {El}_{2} + {El}_{1} ) \\ C ( {Az}_{1} ) ] {X}_{2} + [ - C ( {Az}_{2} ) S ( {Az}_{1} ) + S ( {Az}_{2} ) C ( {El}_{2} + {El}_{1} ) \\ C ( {Az}_{1} ) ] {Y}_{2} - S ( {El}_{2} + {El}_{1} ) C ( {Az}_{1} ) {Z}_{2} \\ {( {Y}_{2} )}_{1 R} = - [ S ( {Az}_{2} ) C ( {Az}_{1} ) - C ( {Az}_{2} ) C ( {El}_{2} + {El}_{1} ) S ( {Az}_{1} ) ] {X}_{2} + \\ [ - C ( {Az}_{2} ) C ( {Az}_{1} ) - S ( {Az}_{2} ) C ( {El}_{2} + {El}_{1} ) S ( {Az}_{1} ) ] {Y}_{2} + \\ S ( {El}_{2} + {El}_{1} ) S ( {Az}_{1} ) {Z}_{2} \\ {( {Z}_{2} )}_{1 R} = [ - C ( {Az}_{2} ) S ( {El}_{2} + {El}_{2} ) ] {X}_{2} + [ S ( {Az}_{2} ) S ( {El}_{2} + {El}_{1} ) ] {Y}_{2} + \\ C ( {El}_{2} + {El}_{1} ) {Z}_{2}\end{matrix}$$

The vector S₂ (X_{S2}, Y_{S2}, Z_{S2})₂ in laser L2 coordinates is transformed into laser L1 using Eq (3) by substituting (X_{S2}, Y_{S2}, Z_{S2})₂ for (X₂, Y₂, Z₂)₂ to produce (X_{S2}, Y_{S2}, Z_{S2})₁R and adding to Eq. set (1), namely (X_{P2}, Y_{P2}, Z_{P2})₁ to translate the rotated vector i.e.

$${( {X}_{S2} , {Y}_{S2} , {Z}_{S2} )}_{1} = {( {X}_{P2} , {Y}_{P2} , {Z}_{P2} )}_{1} + {( {X}_{S2} , {Y}_{S2} , {Z}_{S2} )}_{1 R} \qquad Eq ( 4 )$$

Finally, the skin-to-skin distance SK_{YS2} calculated in laser L1 coordinates is determined (step 74) from the magnitude of the Y component:

SK_{YS2}=|(Y_{S2}−Y_{S1})₁| Eq (5)

Another skin-to-skin distance associated with R₁ is the Y component of P₂ in laser #1 coordinates:

SK_{YP2}=|(Y_{P2})₁|,calculated in Eq (1).

In the preferred embodiment the shape of the ships C1 and C2 and their relative positions are displayed on a visual device. In alternate embodiments various alarms may be used to signal alerts.

The following numeric examples further illustrate features of the present invention.

### Case #1

Let

| | |
|---|---|
| R₁ = 200 feet | |
| Az₁ = 90⁰ | Az₂ = 270⁰ |
| El₁ = 0⁰ | El₂ = 0⁰ |
| S₁ = (−300, −50, 0) | S₂ = (−300, +50, 0) |

Substituting these values into Eq. set (3),

(X₂)_{1R}=[−(−1)×1−0×1×0]X₂+[−0×1+(−1)×1×0]Y₂−0×0Z₂

(X₂)_{1R}=X₂

(Y₂)_{1R}=−[−1×0 −0×1×1]X₂+[−0×0−(−1)×1×1]Y₂+0×1Z₂

(Y₂)_{1R}=Y₂

(Z₂)_{1R}=[−0×0]X₂+[−1×0]Y₂+1 Z₂

(Z₂)_{1R}=Z₂

From Eq (1);

(X_{P2})=200 Cos (90°) Cos (0°)=0

(Y_{P2} )₁=−200 Sin (90°) Cos (0°)=−200

(Z_{P2})₁=200 Sin (0°)=0

From Eq set (4)

(X_{S2}, Y_{S2}, Z_{S2})₁=(X_{P2}, Y_{P2}, Z_{P2})₁+(X_{S2}, Y_{S2}, ZS₂)_{1R}

$$\begin{matrix}{( {X}_{S2} , {Y}_{S2} , {Z}_{S2} )}_{1} = {( 0 , - 200 , 0 )}_{1} + {( - 300 , + 50 , 0 )}_{1 R} \\ = {( - 300 , - 150 , 0 )}_{1}\end{matrix}$$

From Eq (5) the skin-to-skin distance

SK_{YS2}=|(Y_{S2}−Y_{S1})₁|=|(−150+50)₁|=100 feet

### Case #2

Let

| | |
|---|---|
| R₁ = 200 feet | |
| Az₁ = 90⁰ | Az₂ = 270⁰ |
| El₁ = 0 | El₂ = 45⁰ |
| S₁ = (−300, −50, 0) | S₂ = (−300, +50, 0) |

Substituting these values into Eq (3):

$$\begin{matrix}{( {X}_{2} )}_{1 R} = [ - ( - 1 ) \times 1 - 0 \times 0.707 \times 0 ] {X}_{2} + [ - 0 \times 1 + \\ ( - 1 ) \times 0.707 \times 0 ] {Y}_{2} - 0.707 \times 0 {Z}_{2} = {X}_{2} \\ {( {Y}_{2} )}_{1 R} = - [ - 1 \times 0 - 0 \times 0.707 \times 1 ] {X}_{2} + [ - 0 \times 0 - ( - 1 ) \times \\ 0.707 \times 1 ] {Y}_{2} + 0.707 \times 1 {Z}_{2} = 0.707 {Y}_{2} + 0.707 {Z}_{2} \\ {( {Z}_{2} )}_{1 R} = [ - 0 \times 0.707 ] {X}_{2} + [ - 1 \times 0.707 ] {Y}_{2} + 0.707 {Z}_{2} = - \\ 0.707 {Y}_{2} + 0.707 {Z}_{2}\end{matrix}$$

From Eq (1):

(X_{P2})₁=200 Cos (90°) Cos (0°)=0

(Y_{P2})₁=−200 Sin (90°) Cos (0°)=−200

(Z_{P2})₁=200 Sin (0°)=0

From Eq (4)

(X_{S2}, Y_{S2}, Z_{S2})₁=(X_{P2}, Y_{P2}, Z_{P2})₁+(X_{S2}, Y_{S2}, Z_{S2})_{1R}

$$\begin{matrix}{( {X}_{S2} , {Y}_{S2} , {Z}_{S2} )}_{1} = {( 0 , - 200 , 0 )}_{1} + {( - 300 , + 35.35 , 0 )}_{1 R} \\ = {( - 300 , - 164.6 , 0 )}_{1}\end{matrix}$$

From Eq (5), the skin-to-skin distance is:

SK_{YS2}=|(Y_{S2}−Y_{S1})₁|=|(−164.6 +50)₁|=114.6 feet

### Case 3

Let

| | |
|---|---|
| R₁ = 200 feet | |
| Az₁ = 90⁰ | Az₂ = 255⁰ |
| El₁ = 0⁰ | El₂ = 0⁰ |
| S₁ = (−300, −50, 0) | S₂ = (−300, +50, 0) |

Substituting these values into Eq (3),

$$\begin{matrix}{( {X}_{2} )}_{1 R} = [ - ( - 0.966 ) \times 1 - ( - 0.259 ) \times 1 \times 0 ] {X}_{2} + [ - ( - 0.259 ) \times 1 + \\ ( - 0.966 ) \times 1 \times 0 ] {Y}_{2} - 0 \times 0 {Z}_{2} = 0.966 {X}_{2} + 0.259 {Y}_{2} \\ {( {Y}_{2} )}_{1 R} = - [ - 0.966 \times 0 - ( - 0.259 ) \times 1 \times 1 ] {X}_{2} + [ - ( - 0.259 ) \times 0 - \\ ( - 0.966 ) \times 1 \times 1 ] {Y}_{2} + 0 \times 1 {Z}_{2} = - 0.259 {X}_{2} + 0.966 {Y}_{2}\end{matrix}$$

(Z₂)_{1R}=[−(−0.259)×0]X₂+[−0.966×0]Y₂+1Z₂=Z₂

From Eq (1)

(X_{P2})₁=200 Cos (90°) Cos (0°)=0

(Y_{P2})₁=−200 Sin (90°) Cos (90°)=−200

(Z_{P2})₁=200 Sin (0°)=0

From Eq (4)

(X_{S2}, Y_{S2}, Z₂)₁=(X_{P2}, Y_{P2}, Z_{P2}) ₁+(X_{S2}, Y_{S2}, Z_{S2})_{1R}

$$\begin{matrix}{( {X}_{S2} , {Y}_{S2} , {Z}_{S2} )}_{1} = {( 0 , - 200 , 0 )}_{1} + {( - 276.8 , + 126.0 , 0 )}_{1 R} \\ = {( - 276.8 , - 74.0 , 0 )}_{1}\end{matrix}$$

From Eq (5) the skin-to-skin distance:

SK_{YS2}=|(Y_{S2}−Y_{S1})₁|=|(−74.0+50)₁|=24 feet

Finally, the skin-to-skin distance for SK_{YP2}=|(YP₂)₁=200 feet minus the distance from the laser terminals to the adjacent skin locations which is 50+48.3=98.3 if the laser terminals are each 50 feet inboard. Thus, the skin-to-skin distance is 200−98.3=101.7 feet.

It should be understood that the foregoing description is only illustrative of the invention. Various alternatives and modifications can be devised by those skilled in the art without departing from the invention. Accordingly, the present invention is intended to embrace all such alternatives, modifications and variances that fall within the scope of the appended claims.

What is claimed is:

1. A method for determining a pre-selected point-to-point separation between a first craft C1 and a second craft C2, the method comprising the steps of:
providing two laser devices, L1, and L2, each laser device L1 and L2 having position vectors P₁ and P₂, respectively, where L₁ and L₂ are mechanically attached to crafts C₁ and C₂ to form laser/craft pairs L₁/C₁ and L₂/C₂, respectively;
determining a skin location vector S2 of craft C2 in P2 coordinates;
translating the skin location vector S2 to P1 coordinates; and
determining skin separation between crafts C1 and C2 in accordance with the translated position vector.

2. A method as in claim 1 wherein the step of translating the skin location vector S2 to P1 coordinates further comprises the steps of:
transmitting skin location vector S2 to laser/craft pair L₁/C₁; and
combining skin location vector S2 with a skin location vector S1.

3. A method as in claim 2 wherein the step of combining skin location vector S2 with a skin location vector S1 further comprises the steps of:
determining a first set of position parameters for position vector P1, wherein the first set of position parameters comprises:
a first azimuthal value, Az1;
a first elevation value, El1;
determining a second set of position parameters for position vector P2, wherein the second set of position parameters comprises:
a second azimuthal value, Az2; and
a second elevation value, E12.

4. A method as in claim 3 wherein the step of determining the first set of position parameters further comprises the steps of:
generating the first set of position parameters with a first gimbaled pedestal, wherein the first gimbaled pedestal is mechanically attached to the first craft C1 and electrically coupled to a first microprocessor.

5. A method as in claim 3 wherein the step of determining the second set of position parameters further comprises the steps of:
generating the second set of position parameters with a second gimbaled pedestal, wherein the second gimbaled pedestal is mechanically attached to the second platform and electrically coupled to a second microprocessor.

6. A method as in claim 3 wherein the step of translating the skin location vector S2 to P1 coordinates further comprises the steps of:
executing an Euler rotation on the second set of position parameters to represent the second set of position parameters in the P1 coordinate system.

7. A method as in claim 1 wherein the step of providing the two laser devices, L₁ and L₂ further comprises the steps of:
providing laser device L1 with a receive only mode; and
providing laser device L2 with a transmit only mode.

8. A method as in claim 1 wherein the step of providing the two laser devices, L1 and L2, further comprises the step of:
providing laser devices, L1 and L2, with blue-green lasing capability.

9. A method as in claim 1 wherein the step of providing the two laser devices, L1 and L2, further comprises the step of:
providing laser devices L1 and L2 with transceiving capability, wherein the laser devices L1 and L2 each comprise:
a 1550 nm diode lasing wavelength;
a 10 Mbps transmit data rate;
a ±159° pan range; and
a tilt range between 31° up and 47° down.

10. A method as in claim 1 wherein the first craft C1 and the second craft C2 comprise a first marine vessel and a second marine vessel, respectfully.

11. A method as in claim 1 wherein the first craft C1 and the second craft C2 comprise a first spacecraft and a second spacecraft, respectfully.

12. A method as in claim 1 wherein the first craft C1 and the second craft C2 comprise a first land-based vehicle and a second land-based vehicle, respectfully.

13. A method as in claim 1 wherein the first craft C1 and the second craft C2 comprise a first moving platform and a second docking station, respectfully.

14. A laser based system for measuring separation distance between a first platform and a second platform, the system comprising:
an interrogator, the interrogator mechanically attached to the first platform, wherein the interrogator comprises:
a first lasing device;
first-circuitry for interrogating off-platform devices with the first lasing device;
a first gimbal device, the first gimbal device adapted to provide first interrogator azimuthal and elevation coordinates, the first gimbal device adapted to support the first lasing device;
an interrogatee, the interrogatee mechanically attached to the second platform, wherein the interrogates comprises:
a second lasing device:
second-circuitry for communicating with the first interrogator using the second lasing device; and
a second gimbal device, the second gimbal device adapted to provide interogatee coordinates, the second gimbal device adapted to support the second lasing device.

15. A laser based system as in claim 14 wherein the interrogator further comprises:
a rotation module, wherein the rotation module comprises:
a X-Euler module;
a Y-Euler module;
a Z-Euler module;
a translator module, wherein the translator module is coupled to the rotation module; and
a distance calculator module, wherein the distance calculator module is coupled to the translator module.

16. A laser based system as in claim 14 wherein the first gimbal device comprises:
a first pan-tilt pedestal, wherein the first pan-tilt pedestal comprises:
first pan gearing for substantially ±159° pan rotation; and
first tilt gearing for substantially +31°/−47° tilt rotation.

17. A laser based system as in claim 14 wherein the second gimbal device comprises:
a second pan-tilt pedestal, wherein the second pan-tilt pedestal comprises:
second pan gearing for substantially ±159° pan rotation; and
second tilt gearing for substantially +31° and −47° tilt rotation.

18. A method for determining skin-to-skin distance using multi-purpose laser transceiver devices Laser_1 and Laser_2, the method comprising the steps of:
determining a first location vector S1 in Laser_1 coordinates;
determining a second location vector S2 in Laser_2 coordinates;
expressing the second location vector S2 in Laser_1 coordinates; and
determining at least one skin-to-skin distance vector.
